(19) United States
(12) Patent Application Publication
(10) Pub. No.: US 2014/0336934 A1
(43) Pub. Date: Nov. 13, 2014

(54) ENSEMBLE WIND POWER FORECASTING PLATFORM SYSTEM AND OPERATIONAL METHOD THEREOF

(71) Applicant: Atomic Energy Council - Institute Of Nuclear Energy Research, (US)

(72) Inventor: HSIN-FA FANG, TAOYUAN COUNTY (TW)

(73) Assignee: ATOMIC ENERGY COUNCIL - INSTITUTE OF NUCLEAR ENERGY RESEARCH, TAOYUAN COUNTY (TW)

(21) Appl. No.: 13/888,553

(22) Filed: May 7, 2013

(51) Int. Cl. G01W 1/10

(52) U.S. Cl. CPC G01W 1/10
USPC 702/3

(57) ABSTRACT

The present invention relates to an ensemble wind power forecasting platform system and the operational method thereof. According to the present invention, a great amount of wind energy predictions from multiple sources, including numerical weather prediction information, multi-grid prediction information, and multiple wind-energy predicting methods, are integrated and processed for providing users with an ensemble prediction. Thereby, the trend and the possible variation range of the output capacity of a wind farm can be mastered. In addition, by means of the integration platform, the predicted results by different prediction modes can be compared and the history data and the predicted results can be compared as well, which can be used as a basis for improving modes for prediction-mode developers.

### FIELD OF THE INVENTION

The present invention relates to a wind power forecasting platform, and particularly to an ensemble wind power forecasting platform system that can help user know the range of wind power fluctuation and improve the accuracy of wind power forecasting system and the operational method thereof.

### BACKGROUND OF THE INVENTION

Owing to shortage of world energy and problems of greenhouse effect and climate change, renewable energy generation has been regarded as the critical solution to the problems. In particular, the development of wind energy, solar energy, biomass energy, geothermal energy, and hydroenergy are respected. Among these renewable energy generating methods, win energy generation has lower cost and high economic benefit. Thereby, it is developing very rapidly in the recent decade.

In 2005, the European Wind Energy Association and the Greenpeace proposed the project “Wind Force 12”. They planned to make the total capacity of worldwide wind energy generation reach 1,250,000 megawatt and wind energy occupy 12% of the worldwide total power generation in 2020. In 2010, in the European wind energy conference in Warsaw, some proposed the vision of making the wind energy generation occupy 50% of the total power generation in Europe in 2050 and has started planning. Nonetheless, the source the wind energy generation is the wind offered by nature. Due to the huge variance of the natural wind, it is required to have good prediction, so that the safety of the overall power supplying system can be maintained and thus the economic benefit can be satisfied. Generally speaking, if the proportion of wind energy supply is over 5% of the whole power supply, a prediction system is required for maintaining the safety of power supply network. A higher penetration of wind energy also means a higher risk of wind energy power supply.

In fact, in the regions/countries with higher wind energy applications, the researches and system development related to wind power forecasting have been respected; the benefit of wind power forecasting is also evaluated. The results show that for a single wind field, the short-term wind power forecasting in Spain can produce 7 euros of benefit for every kilowatt-hour of electricity; in England, 5 pounds. Thereby, the short-term wind power forecasting has great influence on the economy of wind-energy power generation, and also influences indirectly the success or failure of wind-energy power generation.

In 2011, Taiwan started to promote offshore wind power generation demonstration project for reaching the overall power of above 4 GW. According to the plan, till 2025, renewable energy may reach 12% of the capacity of electrical power devices, and wind power generation will dominate the majority part. Thereby, the stability of power supply will be a major problem. If the total capacity of future domestic wind power generation is estimated to be 2 GW, for the full loading of 2000 hours per year, the increased wind power benefit contributed by wind power forecasting is about 14 million Euros each year. Accordingly, the market of the wind power forecasting system can reach about 2 million Euros. The economic benefit is attractive to wind power operators and researchers.

Currently, there are many wind power forecasting systems which are developed among the world. The more wind energy applications, the stronger the need for more powerful wind power forecasting system and the more the invested research and development resources. A wind power forecasting system usually needs the input of numerical weather prediction (NWP) to provide the prediction basis of wind weather. The prediction results of wind weather will be corrected for producing the prediction results of wind power. The correction method could be physical method or statistical method or the combination of physical method and statistical method. The recent research trend is the ensemble wind energy prediction, which, in general, adopts the numerical weather prediction (NWP) or combines with multiple wind-energy prediction modes for producing multiple predictions at the same prediction time. Thereby, users can master the possible realistic wind power generation in the future time, and thus preparing for electricity deployment.

Many wind power forecasting systems are developed at present in the world. Although the originality is different among inventors, the main focus is placed on how to predict the output of wind farm, model construction, and operation and management. Fewer attentions are paid to the management of training the wind power forecasting models that may improve the accuracy of the wind power forecasting system. Wind power forecasting systems usually haven't the function of collecting the output data (e.g. power production and wind speed) of the predicted wind farm that is not convenient to calculate the prediction error of the wind power forecasting system. The researchers always spend a lot of time to evaluate the prediction error and then try to improve the accuracy of their models. Although the researchers and operators of wind power forecasting are paying a lot of efforts to train their models for getting the more accurate models, it is difficult to judge the accuracy of a wind power forecasting model just depending on the error values of prediction results offered by the researchers and operators because there are too many factors may influence the error value and the researchers and operators usually evaluate the prediction error according to their professional opinion. In our opinion, the accuracy of the models should be compared by using the same inputs under the same specific weather/climate situations in the same criteria. Then we can know which model is more suitable to the specific weather/climate situation.

The training for management of models and multiple numerical weather prediction are less emphasized. It is hard and time consuming to do the research of improving the accuracy and precision of prediction result. It is also hard to users to know which wind power forecasting model is better or more suitable to a specific wind farm. In addition, establishment of the basic data for training is not aware. There is no suitable processing capability for how the prediction satisfies users' needs and how to filter the data adopted by the prediction model itself.

Accordingly. the present invention provides an ensemble wind power forecasting platform system capable of integrating multiple pieces of weather prediction information for mastering the variation of wind energy with certainty. Thereby, better ensemble wind power forecasting can be provided while maintaining the progress and development of the overall prediction mode.

### SUMMARY

An objective of the present invention is to provide an ensemble wind power forecasting platform system and the operational method thereof. Multiple sources of numerical weather prediction information, multi-grid prediction information, and multiple wind power forecasting method can be used for systematically integrating and mastering the trend and possible variation range produced by wind meteorology and wind energy. Thereby, the reliability of predictability and the level of controllable ability of power generating capacity of a wind farm can be enhanced.

Another objective of the present invention is to provide an ensemble wind power forecasting platform system and the operational method thereof. The error of predicted result is evaluated by categories according to multiple-grid geographical locations and weather types. Thereby, the error can be used as a basis for improving future weather prediction modes and thus increasing the accuracy of wind energy prediction.

Still another objective of the present invention is to provide an ensemble wind power forecasting platform system and the operational method thereof. According to the present invention, historic data and predicted results can be inspected. Model developers can improve their models by means of simulation training.

For achieving the objectives described above, the present invention discloses an innovative ensemble wind power forecasting platform system and the operational method thereof. The present invention comprises a first input module, a weather information integration platform, a database, and a display module. The weather information integrated platform is connected with the first input module; the database is connected with the weather information integrated platform; and the display module is connected with the weather information integrated platform. The operation method thereof comprises steps of: inputting plurality pieces of weather information; integrating the plurality pieces of weather information to a weather information integrated platform and producing an ensemble prediction; and displaying the ensemble prediction on a display module and storing the ensemble prediction in a database. The weather information integrated platform integrates plurality pieces of weather information to an ensemble prediction, which is an ensemble wind power forecasting having a plurality of display modes available for users.

### BRIEF DESCRIPTION OF THE DRAWINGS

FIG. 1 shows a schematic diagram of the architecture according to a preferred embodiment of the present invention;

FIG. 2 shows an operational flowchart according to a preferred embodiment of the present invention; and

FIG. 3 shows an operational flowchart according to a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The researches of wind power forecasting in the past are focused on the prediction of the production and management of wind farm. There is no emphasis on mastering the trend of the power output of a wind farm and on the possible variation range according to wind power output prediction. The present invention provides the present ensemble wind power forecasting platform system and the operational method thereof for integrating and optimizing the prediction modes to improve the prediction accuracy and. Finally, the purpose of facilitating stability of wind power supply can thereby be achieved.

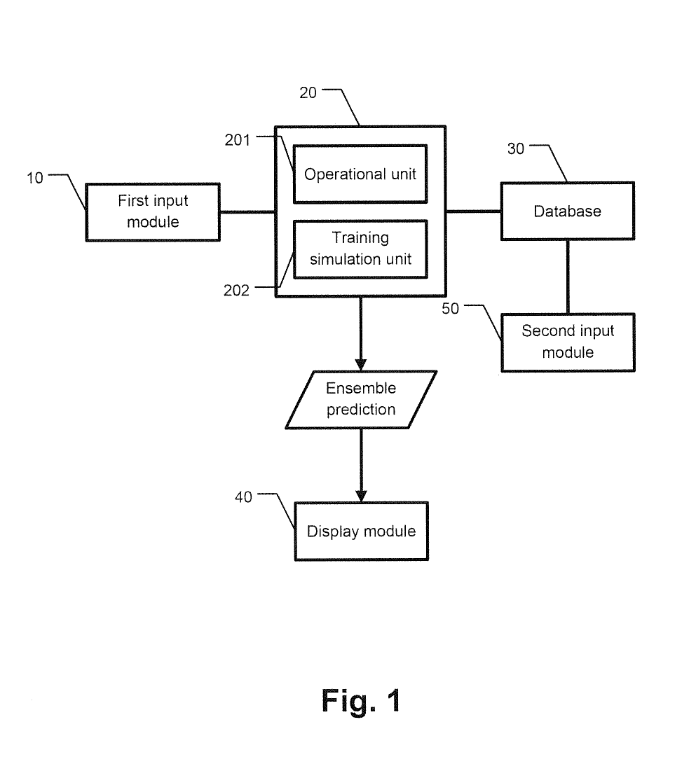

First, refer to FIG. 1. The present invention comprises a first input module 10, a weather information integration platform 20, a database 30, a display module 40 and a second input module 50.

The weather information integration platform 20 is connected with the first input module 10. The database is connected with the weather information integration platform 20. The display module 40 is connected with the weather information integration platform 20.

In addition to the devices described above, the present invention further comprise a second input module 50 connected with the database 30. The weather information integration platform 20 further comprises an operational unit 201 and a training simulation unit 202.

The ensemble wind power forecasting platform system based on the devices described above according to the present invention sifts and integrates weather information from multiple sources, such as the National Centers for Environmental Prediction (NCEP), European Centre for Medium-Range Weather Forecasts (ECMWF),domestic weather forecasting organization, purchase, self laboratory and cooperative laboratory. One of the sources may provide many sets of numerical weather predictions. The huge weather information composed by the numerical weather predictions with grid information for wind power forecasting is transmitted via the Internet. From the remote site, input can be done using the first input module 10 of the present invention. Then the weather information integration platform 20 is used for further processing.

The pieces of weather prediction information from different sources may have different formats and setups. For example, the resolution setup of grid size; the adopted vertical coordinate system differs; or the time resolution mode differs. These differences lead to particular characteristics for each prediction. These predictions cannot truly represent the true value; these weather predictions may higher or lower than the realistic value independently for different situations. Nonetheless, these predictions are produced according to the professional logic and operation. The true value may be contained in the value range of these predictions.

The weather information integration platform 20 has the function of integrating pieces of weather information from various sources, and particularly the pieces of information for different geographical locations. The weather information includes weather type and weather data. Users can install different wind power forecasting system in the operational unit 201. There are a lot of wind power forecasting systems are developed or in development. Different wind power forecasting systems developed by different logic may need different kind and number of weather information ad parameters. Therefore, the operational unit 201 has an ability of conversing and sifting the weather information from different sources to produce weather prediction sets which can match the requests of each wind power forecasting system working for different wind farms. The number of weather prediction set is not only the sum of the total source. One source may provide a number of weather prediction data sets for the grids we concern. So the number of weather predictions sets produced by the operational unit 201 may be the sum of the product of the number of each source's weather prediction data sets and the number of the concerned grids. The number of wind power prediction produce by the operational unit 201 for a wind farm will be the product of the number of the wind power prediction models and the number of the weather prediction sets. Then an ensemble prediction for wind power forecasting is produced by the operational unit 201. The result will be stored in the database 30 and displayed on the display module 40.

The display module 40 has a menu interface, which is provided for the users to adjust how to display the ensemble wind power forecasting produced by the operational unit 201. The users can select different combination of wind power forecasting results depend on their consideration for comparison, for example, the same wind energy predicting model but different numerical weather predictions, the same grid point but different numerical weather predictions, or the same numerical weather prediction but different wind energy predicting models, and so on. Thereby, the display function is very flexible for improving the efficiency of wind power forecasting research.

After the operational unit 201 completes processing, in addition to storing the result to the database 30, the result is also displayed on the display module 40 for the users.

For purposes of error evaluation and training of the models, the database 30 can also stores the monitoring data of predicted wind farms, including the status values of the wind power generation, the wind speed, and the wind direction, input by the users via the second input module 50. The data can be extracted afterwards and used as the basis for error evaluation. Because the differences in data formats and in recording frequencies of wind farms, the second input module 50 should be able to inputting parameters such as data locations, recording frequencies, and sifting criteria. In addition, due to limitations by various innate conditions, the information input via the second input module 50 is not limited to the data measured and input real-timely. The data from a wind farm operator can be shared afterwards for future statistics, analysis, evaluation, and reference according to the present invention.

In addition to the practical error evaluation function described above, the present invention also has the capability of training application. The training simulation unit 202 in the weather information integration platform 20 according to the present invention can let users to read history data of a specific period from the database 30, establish a simulated situation for prediction training, or probing how to improve and adjust the prediction mode. Besides, by means of training simulations, the users can understand more clearly how to use different numerical weather predictions, grid prediction information, and wind energy predicting methods for improving the reliability and command on the prediction of the capacity of power generation for a wind farm.

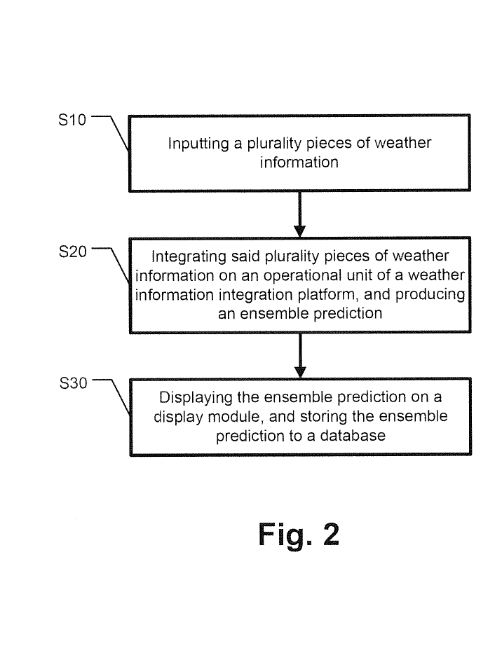

According to the functions provides by the above structure, the operational method according to the present invention, ash shown in FIG. 2, comprises steps of:

Step S10: Inputting a plurality pieces of weather information;

Step S20: Integrating the plurality pieces of weather information on a weather information integration platform, and producing an ensemble prediction; and

Step S30: Displaying the ensemble prediction on a display module, and storing the ensemble prediction to a database.

The ensemble prediction above is an ensemble wind power forecasting having a plurality of display modes for users.

According to the operations of the above steps, the pieces of weather information the users input include numerical weather prediction, grid prediction information, and wind-energy predicting methods, which will be integrated by the weather information integration platform 20 as the ensemble prediction. Thereby, the users can observe via the display module 40 conveniently and use the menu interface for proper judgment, evaluation, and adjustment.

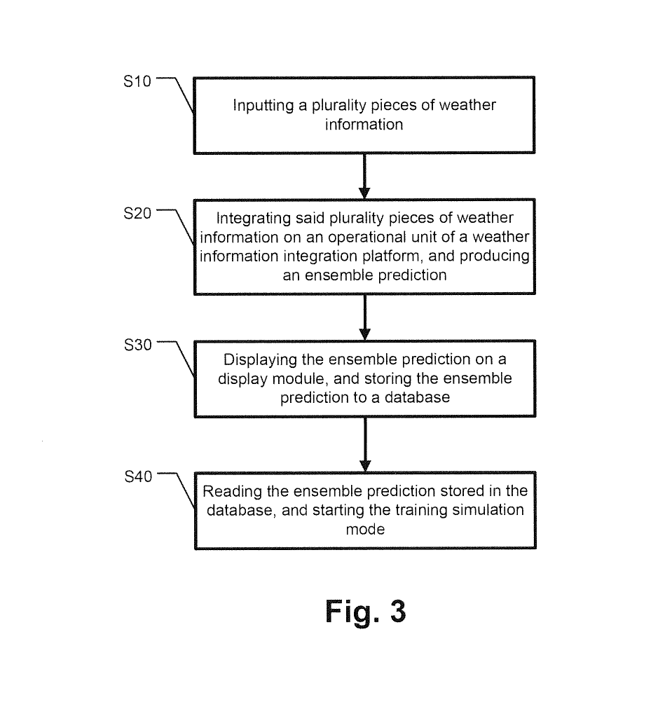

Furthermore, the present invention has the function of simulation training. Refer to FIG. 3. After storing the ensemble prediction to the database 30, the present invention further comprises a step S40 of reading the ensemble prediction stored in the database, starting the training simulation mode, and comparing the stored ensemble prediction with the current predicted result. Here, the history data stored in the database 30 is the material for training and simulation. The users can use various parameter conditions and models for improving the accuracy of wind power prediction.

By using the ensemble wind power forecasting platform system and the operational method according to the present invention, various pieces of wind-energy predicting information can be integrated on the same platform, so that users can evaluate, analyze, compare, and sift information objectively and comprehensively. According to the provided ensemble wind energy prediction, the trend and the possible variation range of the output capacity of a wind farm can be known well. A standard for training, improvement, and evaluations can be established as well. In the current day of increasingly respecting wind energy, the present invention is not only an important promoter of clean energy but also undoubtedly an explorer for higher economic benefits.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An ensemble wind power forecasting platform system, comprising:
a first input module;
a weather information integration platform, connected with said first input module, the weather information integration platform comprises an operational unit;
a database, connected with said weather information integration platform; and
a display module, connected with said weather information integration platform;
a second input module connected with said database;
wherein the operational unit of said weather information integration platform integrates a plurality pieces of weather information to an ensemble prediction, and the ensemble prediction comprise a plurality of numerical weather predictions, a plurality pieces of grid prediction information, and a plurality of wind-energy predicting methods; and said ensemble prediction is an ensemble wind power forecasting having a plurality of display modes for users.

2. The ensemble wind power forecasting platform system of claim 1, wherein said weather information integration platform comprises a training simulation unit.

3. The ensemble wind power forecasting platform system of claim 1, wherein said display module has a menu interface.

4. An operation method of an ensemble wind power forecasting platform system, comprising steps of:
inputting a plurality pieces of weather information;
integrating said plurality pieces of weather information on an operational unit of a weather information integration platform, and producing an ensemble prediction; and
displaying said ensemble prediction on a display module, and storing said ensemble prediction to a database;
wherein said ensemble prediction is an ensemble wind power forecasting having a plurality of display modes for users, and the plurality pieces of weather information comprise a plurality of numerical weather predictions, a plurality pieces of grid prediction information, and a plurality of wind-energy predicting methods.

5. The operation method of an ensemble wind power forecasting platform system of claim 4, and further comprising a step of reading said ensemble prediction stored in said database, starting the training simulation mode, and comparing said stored ensemble prediction with the current predicted result after said step of storing said ensemble prediction to said database.
